(19) United States
(12) Patent Application Publication
(10) Pub. No.: US 2013/0227316 A1
(43) Pub. Date: Aug. 29, 2013

(54) BATTERY MODULE SYSTEM AND METHOD FOR INITIALIZING BATTERY MODULES

(71) Applicants: Henrik Bengtsson, Goteborg (SE); Magnus Jonsson, Vastra Frolunda (SE); David Helgeson, Kungalv (SE); Dag Lundström, Onsala (SE); Niklas Angebrand, Goteborg (SE)

(72) Inventors: Henrik Bengtsson, Goteborg (SE); Magnus Jonsson, Vastra Frolunda (SE); David Helgeson, Kungalv (SE); Dag Lundström, Onsala (SE); Niklas Angebrand, Goteborg (SE)

(73) Assignee: Alelion Batteries AB, Molndal (SE)

(21) Appl. No.: 13/883,165

(22) PCT Filed: Nov. 5, 2010
(86) PCT No.: PCT/SE2010/051214

§ 371 Date: May 2, 2013

(51) Int. Cl. G06F 1/26

(52) U.S. Cl. CPC G06F 1/26
USPC 713/300

(57) ABSTRACT

Battery system comprising a plurality of control nodes, where each control node comprises an electronic circuitry containing control information adapted to control and monitor a battery assembly and further comprising circuitry for serial communication with other control nodes, where each control node is mounted to a battery assembly, and where each control node is adapted to receive a unique node number and to store the node number in a memory, where the assignment of a node number is performed when the control node is connected to a serial bus communication line for the first time. The advantage of the invention is that a battery module can easily be initiated by the battery system when it is connected to the system for the first time. There is thus no need to run a specific initiation process in the production of the module. The software version of a battery module is also checked during the initiation, which will prevent battery modules with outdated software to be used.

### TECHNICAL FIELD

This invention relates to a battery system adapted to control and initiate a plurality of battery modules. In particular, the invention relates to a rechargeable battery system for applications requiring a relatively high power, such as powering vehicles.

### BACKGROUND OF THE INVENTION

Rechargeable batteries of the lithium-ion (Li-ion) or nickel-cadmium (Ni-Cd) type, or similar, have become increasingly interesting as an energy source for driving vehicles (cars, golf-carts, motor-bikes etc.) and other devices, such as boat engines and cleaning machines, as well as for powering e.g. cellular network base stations (together with solar or wind power equipment) in remote areas.

In such applications several battery cells are connected in series and/or parallel in a battery module such as to be capable of delivering the required power/current/voltage. Normally, a battery module of this type includes a battery management system (BMS), i.e. electronic equipment for monitoring, controlling and/or balancing the cells and the battery pack.

Smaller battery packs for computers, camcorder and the like have been on the market for some years and are rather well developed. Larger battery packs, i.e. battery packs for driving e.g. vehicles, make use of larger and heavier battery cells and operate with higher currents (typically with a power output of at least around 100 W and a current exceeding 10 A). This leads to somewhat different challenges, for instance how to connect a plurality of battery modules and to be able to control the battery modules individually.

A further problem is how to initiate each battery module individually in order to be able to communicate with the individual battery modules. Conventional control systems may e.g. see all the battery modules as one unit that is to be controlled. There is thus room for an improved battery system.

### SUMMARY OF THE INVENTION

An object of this invention therefore to provide a battery system that can initiate each battery module of a battery system individually. A further object of the invention is to provide a battery system where a control node in a separate battery module can initiate the remaining battery modules.

This object is achieved by the battery system defined by the technical features contained in independent claim 1. The dependent claims contain advantageous embodiments, further developments and variants of the invention. Claim 8 describes a method for initiating battery modules.

The invention concerns a battery system comprising a plurality of control nodes, where each control node comprises an electronic circuitry containing control information adapted to control and monitor a battery assembly and further comprising circuitry for serial communication with other control nodes, where each control node is mounted to a battery assembly.

The invention is characterized in that each control node is adapted to receive a unique node number and to store the node number in a memory, where the assignment of a node number is performed when the control node is connected to a serial bus communication line for the first time.

In this way, a flexible battery system is obtained, in which each battery module of the battery system can be initiated individually and where it is easy to replace a battery module without having to initiate the complete battery system. It is also possible to allow control or reconditioning of a battery module without having to initiate the battery module when it is installed in the battery system again.

In the battery system, the node numbers of the battery modules are stored in a node number list together with a unique serial number of each battery module. In this way, the system can detect if a used battery module is connected to the battery system.

Further, a battery system in which all control nodes of the battery system are identical is provided for. In this way, a specific central unit is not necessary.

### BRIEF DESCRIPTION OF DRAWINGS

In the description of the invention given below reference is made to the following figure, in which:

FIGS. 1-4 shows a schematic view of a first embodiment of a battery system according to the invention,

FIGS. 5-7 shows a schematic view of a second embodiment of a battery system according to the invention, and

FIG. 8 shows an example of a battery module used in the battery system.

### DESCRIPTION OF EXAMPLE EMBODIMENTS OF THE INVENTION

The battery system 1 comprises a plurality of battery modules 2, adapted to be arranged in e.g. an electric vehicle or a cellular network base station. Each battery module comprises a plurality of rechargeable battery cells, where a number of battery cells are arranged in parallel in battery blocks, and where a number of battery blocks are arranged in series to form a battery assembly 4. A control node 3 in the form of an electronic control circuitry 8 arranged on a PCB 7 is mounted on the battery assembly such that a battery module is obtained.

A control node 3 comprises an electronic circuit 8 for battery management which in the described example, apart from the serial communication, is arranged to monitor, control and/or balance said battery blocks in the battery assembly. It is important that each battery block can be monitored, controlled and/or balanced individually in order to optimise the capacity and life of the battery assembly. The most important measures are the battery block voltage, the charge and discharge current through the battery block and the battery block temperature. The electronic circuit thus comprises one circuit block for each battery block. Each circuit block is configured to measure each battery block between the positive and negative terminals through the mounting flanges of the metal plates of the battery assembly. The circuit block will measure the voltage for each battery block. This voltage can be used to monitor and to balance the battery blocks individually in each battery assembly. The electronic circuit further comprises temperature sensors which measures the temperature at each mounting flange. In this way, the temperature of the metal plate can be measured with a high accuracy on the PCB. The temperature measured will be an average temperature of the metal plate connected to the mounting flange. By comparing the temperature measured at each mounting flange, the temperature distribution in the battery assembly can be estimated. It is also possible to estimate the temperature of each battery block. This can in turn be used to estimate the power loss in each block, as well as the internal resistance of each block. The inner resistance can be used to estimate the aging of a battery block. Further, the voltage and temperature measures can be sent to an external control unit via the communication line.

The electronic circuit further comprises a computer processor of some kind, either a stand-alone processor or integrated in a microcontroller. The circuit also comprises memory means in which control software may be stored, together with set-up parameters such as the node number and the unique serial number of the node. Further are I/O-circuits and a serial bus communication circuit comprised.

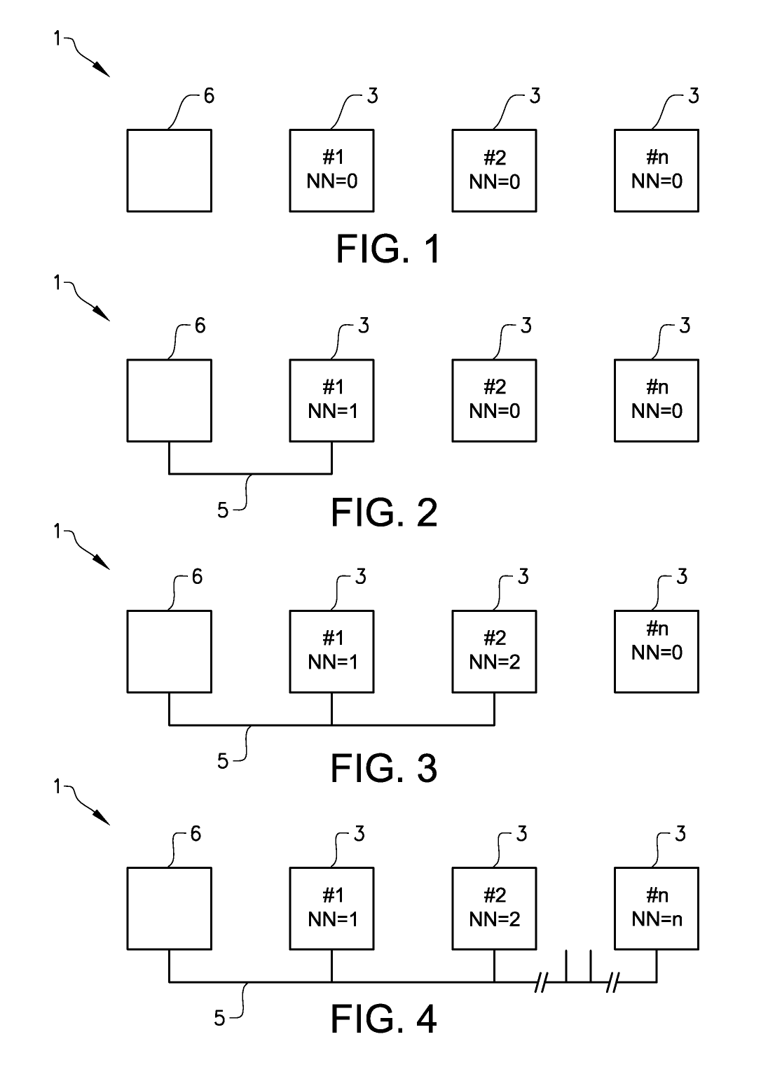

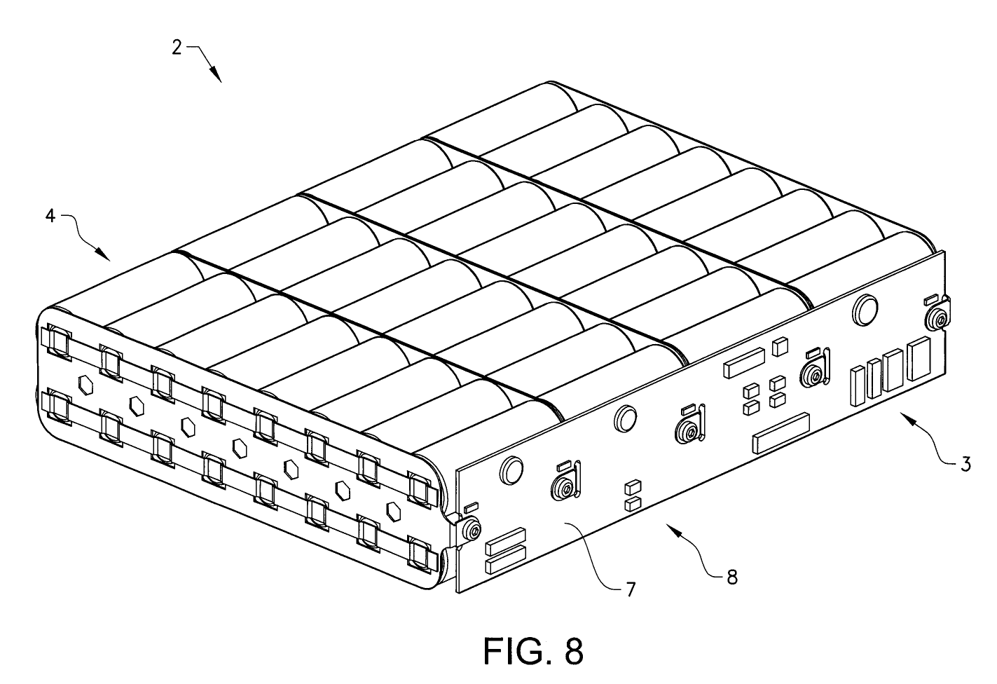

In the first embodiment, shown in FIGS. 1 to 4, the battery system comprises a dedicated central node 6 connected to the control nodes 3 of each battery module 2. The central node 6 may be either a stand-alone node adapted to control the battery system or a control unit integrated in the vehicle. The connection between the central node and the control nodes is done by a serial communication line 5. A battery system ready to be used is shown in FIG. 4. The control nodes may be powered directly by the battery module on which the respective control nodes are mounted, through the communication line or by an external power supply. An example of a battery module 2 comprising a control node 3 and a battery assembly 4 is shown in FIG. 8. The communication line is used by the central node to give instructions to the control nodes and to receive messages from the control nodes. The used protocol may be any known protocol, e.g. a CAN (Controller Area Network) protocol. When the central node communicates with the control nodes, it is important that each control node can be identified. Each node is thus provided with a unique node number, which differs from a unique identity number or serial number of the control node.

The node number may be assigned to the control node in different ways. In a first embodiment of the invention, the central node will assign node numbers to all control nodes in the battery system. The central node is initiated before the central node is connected to the battery system, preferably during the manufacture of the central node or in a specific initiation station. In the described example, the system is an electrical vehicle. The power supply of the central node may be integrated in the central node or may be an external power supply, e.g. a back-up power supply for the electronic control system of the vehicle. In this way, the power batteries of the vehicle can be disengaged during e.g. an accident but the control electronics will still run. In this embodiment, the node number of all control nodes is set to a predefined number, e.g. zero.

Before an initiation of the battery system, the central node, being a master node in the system, is powered up. This is shown in FIG. 1. When the central node is running, the initiation can begin. This is done by connecting a first control node 3 to the communication line 5, as shown in FIG. 2. When the control node is connected to the communication line, a communication link is established between the central node and the first control node. Before or after the initiation of a control node, the central node checks the software version of the control node. If the software version of the control node is not the proper one, the software is updated by software stored in the central node. In this way, it is only important to ensure that the software in the central node is the proper version, since the software of the control nodes will be updated automatically. The proper software version may be either the latest version, i.e. the central node checks the date of the software of the control node and updates it if the date is earlier than the software of the central node. The proper software version may also be a specific software version adapted for specific battery modules or a specific use. If the software version of the control node differs from that software version, the software is updated.

The central node also asks the newly connected control node for its node number (NN). If the central node detects that the node number of the newly connected control node is the predefined number, e.g. zero, it concludes that the first control node is a new control node. The central node will now generate a new, unique node number which is assigned to the first control node. In the shown example, the node number of the first control node is set to one. The node number is stored in a memory in the first control node. At the same time, the node number together with the unique serial number of the first control node may be stored in a node list by the central node. The node list may either be a list in the central node or may be stored in an external memory, e.g. comprised in the master control unit of the electrical vehicle. In this way, the central node will be able to keep track of the individual control nodes in the battery system. This is of advantage e.g. when a control node is to be replaced.

If the node number of the newly connected control node is not the predefined number, the central node will know that the control node is a pre-used control node. The central node will also in this case check the software version of the control node and will update it if the software version differs from the proper one stored in the central node. The central node will then generate a new node number that will be stored in the control node, overwriting the previous node number. It is also possible that the previous node number is cleared during a software update. The central node may store the serial number and the node number of the control node in the node list. The central node may also store information about that the control node was previously used and in this case also information regarding the previous use, e.g. running time, total power stored, the number of charge/discharge cycles, production time etc. This information may be used to compensate the running parameters of the pre-used battery module.

When the first control node is assigned a node number, a ready signal is given by the central node which indicates that a second control node can be connected to the communication line, as shown in FIG. 3. The second control node is connected to the communication line. The communication link is established between the central node and the second control node. The central node detects that the node number of the newly connected control node is the predefined number, which means that the control node is a new control node. The central node will now generate a new, unique node number which is assigned to the second control node. In the shown example, the node number of the second control node is set to two. The node number is stored in the second control node. At the same time, the node number together with the unique serial number of the second control node may be stored in the node list by the central node.

This initiating process is continued by connecting all the control nodes in a consecutive way, one after the other, until all control nodes are connected to the communication line and all control nodes are assigned a node number, as shown in FIG. 4. It is to be noted that the physical order of the control nodes is not of importance in the described battery system. Instead, it is the order in which the control nodes are connected to the central node that determines the node order and the node numbers assigned to the control nodes. In this way, the physical order of the control nodes may be one and the actual node order may be another. One advantage of this is that all battery modules may be removed from the battery system for control or reconditioning and can then be reinstalled in the battery system in another order. The prior position of each battery module must thus not be known during installation. There is thus also no need to reinitiate all battery modules after the control or recondition, as long as the assigned node number of a control node is not altered during the control or reconditioning. If the node number in a control node is altered during the control or reconditioning, the central node must initiate that control node again.

When all control nodes are assigned a node number, the initiation is finished and the central node goes to a standby mode. The user may terminate the initiation process or there may be a time-out after a predetermined time interval that terminates the initiation process.

If the central node detects that the software of a control node is not the proper one, the software of that control node is also updated from the central node during the initiation. In this way, it is enough to make sure that the central node is equipped with the proper software. This simplifies the quality follow up of the system and assures that none of the control nodes is used with outdated software. It is also possible for the central node to detect the type of node that is connected to the communication line during the initiation. If the central node detects that a control node that is not intended for the battery system in question is connected to the central node, it may give a warning signal and may halt the initiation process. In this way, it is assured that only valid control nodes are used in the battery system. The central node may also compare the unique serial number of a control node with a list of approved control nodes in order to ensure that only approved control nodes are used in the battery system. When a control node having a serial number not in the list is connected to the central node, the central node may give a warning signal and may halt the initiation process. The list of approved serial numbers of the control nodes may be stored in the central node or may be found in an external database, to which the central node has access. This can prevent false control nodes from being used in the battery system. This is especially important when lithium-ion cells are used, which may otherwise be damaged.

Each control node 3 is mounted to a battery assembly 4 and is adapted to monitor, control and/or balance a battery assembly or each battery pack in the battery assembly. In this way, the central node may ask for specific data and the control node may reply with the data. It is also possible that the control node sends a message to the central node, e.g. when a value exceeds a predefined measure or when an abnormal situation has occurred. The control node is adapted to perform most of the monitor, control and/or balance of a battery assembly independently, without the central node. A control node may communicate with the central node when the central node asks for information or when the control node is set to send data to the central node. A control node may send data to the central node either on a regular basis or when a specific value is measured, e.g. when an abnormal measure is detected.

When a control node is to be replaced, e.g. when the node or the battery assembly is broken or when the battery assembly needs to be replaced due to ageing, the control node is disconnected and a new control node is connected to the communication line. The central node will now detect that a new control node which does not have a node number is connected to the battery system. The central node is preferably placed in a specific initiation mode in which it polls all control nodes and detects the missing control node number. The missing control node number is now assigned to the new control node and the central node stores the serial number of the new control node with the node number in the list. Before the new control node is assigned the node number, the central node will first check the software version of the new control node and will update the software if required. If more than one control node is to be replaced at the same time, the new control nodes are connected to the communication line one at the time, as described above. When the new control node or the control nodes are all assigned a node number, the initiation is completed.

When a new control node is connected to the communication line during a replacement and the central node detects that the new control node is already provided with a node number, it will compare the node number and the serial number of that control node with the node list in order to establish if the new control node is a new control node or a control node that has already been used in the battery system and is reconnected. If the node number and the serial numbers match the node list, no further action is taken by the central node. If the node number and the serial numbers do not match, the central node may either assign the node number of the removed control node to the new control node, or may assign a new node number to the new control node. The serial number and the node number of the new node are also stored in the node list. If the new control node is assigned a new node number, the node number of the removed control node is removed from the node list.

In this way, both new control nodes, i.e. control nodes that has not been assigned a node number, and previously used control nodes can be used to replace a broken control node in the battery system.

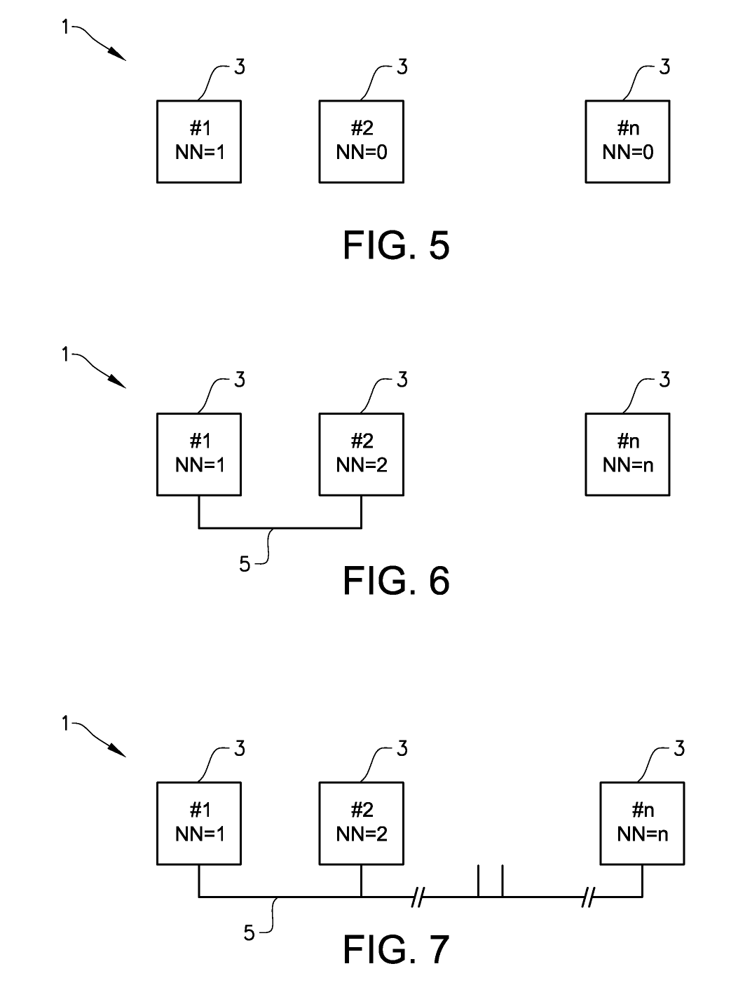

In a second embodiment, shown in FIGS. 5 to 7, the initiation process is performed without a dedicated central node. Instead, a first control node is used to initiate all the control nodes and to assign node numbers to the control nodes. In this embodiment, the battery system comprises several control nodes 3, each mounted to a battery assembly, thereby forming battery modules 2. The connection between the control nodes is done by a serial communication line 5. The control nodes may be powered either directly by the battery assembly on which the respective control nodes are mounted, or may be powered by an external power source, either through the communication line or through a separate cable. The communication line is used by the control nodes to communicate with each other, both during the initiation and during regular use.

In this embodiment, a first control node will function in the same way as the central node described above. The first control node will assign node numbers to the other control nodes in the battery system. This is done in the following way. The first control node is powered either by the batteries of its battery assembly or by an external power source, e.g. a back-up power supply for the electronic control system of the vehicle. In this way, the power batteries of the vehicle can be disengaged during e.g. an accident but the control electronics will still run. In this embodiment, the node number of all control nodes is set to a predefined state, e.g. zero.

Before an initiation of the battery system, the first control node, being the first node in the system, is powered up and is placed in an initiation mode. The first control node will now assign a node number to itself, i.e. node number one. The first control node may also store the node number and the serial number in a node list. This is shown in FIG. 5.

When the first control node has assigned a node number to itself, a ready signal is given which indicates that a second control node can be connected to the communication line, as shown in FIG. 6. The second control node is thus connected to the communication line. A communication link is established between the first control node and the second control node. The first control node detects that the node number of the newly connected control node is a predefined number, e.g. zero, which means that the control node is a new control node. The central node will now generate a new, unique node number which is assigned to the second control node. In the shown example, the node number of the second control node is set to two. The node number is stored in the second control node. At the same time, the node number together with the unique serial number of the second control node may be stored in the node list by the first control node.

This initiating process is continued by connecting all the control nodes in a consecutive way, one after the other, until all control nodes are connected to the communication line and all control nodes are assigned a node number, as shown in FIG. 7. It is to be noted that the physical order of the control nodes is not of importance in the described battery system. Instead, it is the order in which the control nodes are connected to the first control node that determines the node order and the node numbers assigned to the control nodes. In this way, the physical order of the control nodes may be one and the actual node order may be another.

When all control nodes are assigned a node number, the initiation is finished and the first control node goes to a standby mode. The user may terminate the initiation or there may be a time-out after a predetermined time interval.

If the first control node detects that the software of another control node is not the proper one, the software of that control node is also updated from the first control node, either before or after the initiation, i.e. before or after the node number is assigned to the control node. In this way, it is enough to make sure that the first control node is equipped with the proper software. This simplifies the quality follow up of the system and assures that none of the control nodes is used with outdated software. It is also possible for the first control node to detect the type of node that is connected to the communication line during the initiation, as described above, such that only approved nodes are used in the battery system.

When a control node is to be replaced, e.g. when the node or the battery assembly is broken or when the battery assembly needs to be replaced due to ageing, the faulty control node is disconnected. The first control node is placed in the initiation mode and a new control node is connected to the communication line. The first control node will now detect that a new control node which does not have a node number is connected to the battery system. The first control node preferably polls all control nodes and detects the missing control node number. The missing control node number is now assigned to the new control node and the first control node stores the serial number of the new control node with the node number in the node list. Before the new control node is assigned the node number, the first control node will check the software version of the new control node and will update the software if required. If more than one control node is to be replaced at the same time, the new control nodes are connected to the communication line one at the time, as described above. When the new control node or the control nodes are all assigned a node number, the initiation is completed.

If the first control node detects that the new control node is already provided with a node number, it will compare the node number and the serial number of that control node with the node list in order to establish if the new control node is an unused connected control node or a control node that has already been used in the battery system and is reconnected. If the node number and the serial numbers match the node list, no further action is taken by the first control node. If the node number and the serial numbers do not match, the first control node may either assign the node number of the removed control node to the new control node, or may assign a new node number to the new control node. The serial number and the node number of the new node are also stored in the node list. If the new control node is assigned a new node number, the node number of the removed control node is removed from the node list.

In this way, both new control nodes, i.e. control nodes that has not been assigned a node number, and previously used control nodes can be used to replace a broken control node in the battery system.

In a development of the second embodiment, the first control node checks the software version of the second control node and updates it if necessary before or after the initiation of the control node. The first control node also assigns the second control node a node number and stores the node together with the serial number of the second control node in the node list. When the initiation of the second control node is completed, the first control node transfers the assignment right to the second control node. If the node list is stored in the first control node, the node list is also transferred to the second control node. When the information transfer to the second control node is completed, a ready signal is given and a third control node can be connected to the communication line. When the third control node is connected, the second control node will check the software version of the third control node and update it if necessary. The second control node will also assign the third control node a node number that the third control node stores in a memory. The node number and the serial number of the third control node is stored in the node list, and this is then transferred to the third control node, together with the assignment right. The remaining control nodes are then connected to the communication line in a consecutive way, one after another. When all control nodes are assigned a node number, the initiation is aborted.

The invention is not limited by the embodiments described above but can be modified in various ways within the scope of the claims.

1. Battery system

2. Battery module

3. Control node

4. Battery assembly

5. Communication line

6. Central node

7. Printed circuit board (PCB)

8. Electronic circuit

1. A battery system comprising:
a plurality of control nodes where each control node comprises an electronic circuitry containing control information adapted to control and monitor a battery assembly and further comprising circuitry for serial communication with other control nodes, where each control node is mounted to a battery assembly,
wherein each control node is adapted to receive a unique node number and to store the node number in a memory, where the assignment of a node number is performed when the control node is connected to a serial bus communication line for the first time.

2. The battery system according to claim 1, wherein the node number of a new, uninitiated control node is set to a predefined number.

3. The battery system according to claim 1, wherein the control node further comprises information of the software version stored in the control node.

4. The battery system according to claim 1, wherein a control node is adapted to be initiated by an external control node.

5. The battery system according to claim 1, wherein a control node is adapted to be initiated by a control node that is connected to the communication line at an earlier stage.

6. The battery system according to claim 1, wherein a control node comprises memory means for storing a node list of the nodes comprised in the battery system.

7. The battery system according to claim 6, wherein the control node further stores the serial number of each control node in the node list.

8. A method comprising:
initialising a plurality of battery modules in a battery system, where each battery module comprises a control node having an electronic circuit comprising means for storing information, the method further comprising:
connecting a first control node to a second control node with a serial communication line, where the second control node is initialised when it is connected to the first control node for the first time, where the initialisation comprises assigning a node number to the second control node,
connecting a third control node to the serial communication line, where the third control node is initialised when it is connected to the communication line for the first time, where the initialisation comprises assigning a node number to the third control node, and
connecting the remaining control nodes to the communication line in a consecutive manner, one after the other, such that all remaining control nodes are assigned a node number.

9. The method according to claim 8, where the software of the control nodes are updated with software stored in the first control node, if the first control node decides that the software should be updated.

10. The method according to claim 8, where the first control node is a central control node that is arranged to control the control nodes.

11. The method according to claim 8, where the first control node is identical to the remaining control nodes.

12. The method according to claims 8, where the assignment of the node number is controlled from the first control node.

13. The method according to claim 11, where the assignment of the node number is controlled from the control node that was last assigned a node number.
